(19) United States
(12) Patent Application Publication
(10) Pub. No.: US 2010/0287220 A1
(43) Pub. Date: Nov. 11, 2010

(54) Dynamically Encoding Types and Inhabitants in a Relational Database

(75) Inventors: Brian S. Aust, Redmond, WA (US); Allen L. Brown, JR., Bellevue, WA (US); Chris D. Karkanias, Sammamish, WA (US); David G. Campbell, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/435,407

(22) Filed: May 5, 2009

(51) Int. Cl. G06F 17/30

(52) U.S. Cl. 707/955; 707/954

(57) ABSTRACT

Described is a technology, such as for representing scientific data and information, in which a database table contains rows of type data representing types, and term data representing terms that inhabit the types. Types include composite types (e.g., that represent entities), and instances of relation types that express relationships between types, between a type and a term, or between terms. Types and/or terms may have multiple relationships with one another, and a relationship may span database tables. A new relationship may be established by adding a new row to the database table to represent a new relation term, along with one or more similar rows to represent the relation role terms associated with that relation term; relationships may be removed by removing rows. As a result, the database table may change its state rapidly, without needing to change the database schema.

### BACKGROUND

It is common to use database schemata to represent an abstraction of an enterprise. The populated tables of the database constitute a concrete realization of that abstraction.

At the same time, classical relational database design assumes that the schemata of base tables evolve very slowly relative to the content of the base tables. In general this works well to model most aspects of an enterprise, including its structure, because the structure of a typical enterprise evolves slowly. As a result, whenever a table needs to be changed or a new table needs to be integrated into the database, an administrator or the like performs such tasks.

In contrast to the structure of an enterprise, the state of an enterprise, as represented by the content of tables, may evolve quite rapidly. For example, consider scientific research aspects of an enterprise. One view of scientific research is that its purpose is to create new abstractions, in which measurements and observations constitute concrete instances of those abstractions. Such abstractions may be created, considered and discarded at a reasonably rapid pace. For at least this reason, relational database schemata as currently realized are not particularly good for representing such scientific (or other) abstractions that are regularly in flux.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a database table contains rows of type data representing types, and term data representing terms that inhabit the types. Among the types are composite types (e.g., types composed of one or more ‘members’, each representing an attribute of the type), and relation types that specify relationships between types, between a type and a term, or between two terms. A composite type has a relationship with a member type according to a member definition. A relation type has a relationship with a role term according to a role definition.

In one aspect, creation of a new type of relationship is established by adding a new row to the database table representing relation types. A new instance (term) of an existing relation type may also be created. Two types, two terms, or a type and a term may have more than one relationship with one another, via two or more relation instances, each of which is of some relation type. A relationship may span database tables.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in a computing environment in which database access is exemplified.

FIG. 2 is a representation of a type and its possible associations, including an association between a type and a term.

FIG. 3 is a representation of a composite type and its association with a member term.

FIG. 4 is a representation of a relation type and its association with a role term.

FIG. 5 is a representation of a graph showing an example of types and terms (nodes) are related to one another by relation types (nodes) describing edges.

FIG. 6 is a representation of how nodes (such as types) may have multiple relationships with other nodes, and/or how relationships may span tables.

FIG. 7 shows an illustrative example of a computing environment into which various aspects of the present invention may be incorporated.

### DETAILED DESCRIPTION

Various aspects of the technology described herein are generally directed towards using a database with types and inhabitants (terms) to accommodate the rapid evolution of data, information and knowledge. In general, the types and terms provide an environment in which any arbitrary data model may be defined and populated, without the need to alter the underlying database schemata. In this way, the database may be considered as a database of model metadata and model data, where the metadata is represented relationally.

As will be understood, the use of type systems in development contexts allows the flexible and rapid evolution of abstractions. To this end, there is provided an explicit representation of types, relationships among types and relationships between types and instances. The use of types, and terms (e.g., similar to concrete instances) that inhabit types allows adding concepts to a database without changing the underlying schema.

While the examples herein are directed towards enterprise and scientific scenarios, and while the technology is particularly beneficial with scientific data, it should be understood that any of the examples and/or applications described herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and data processing in general.

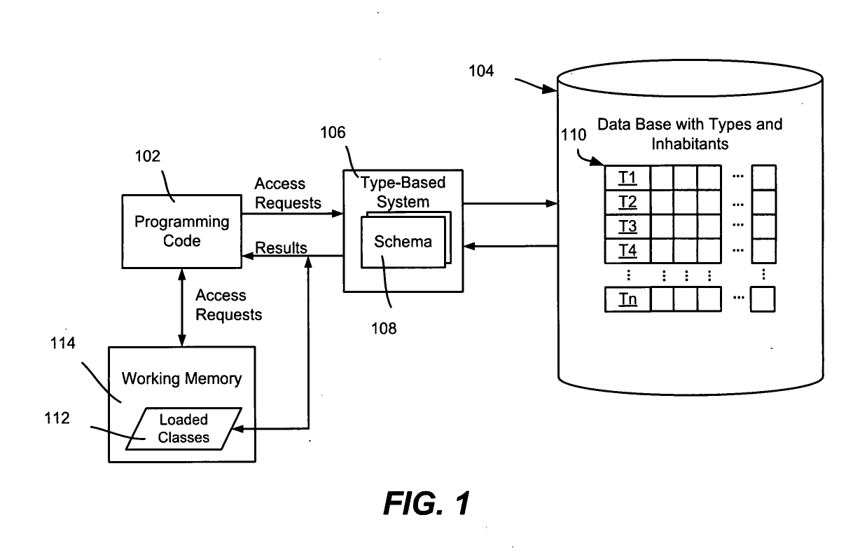

Turning to FIG. 1, in general, a programmer writes programming code 102 that is then used to access (e.g., query) a database 104. As described herein, a type-based system 106 or the like comprising a schema 108 allows the program to access a database table 110 that contains types (e.g., T1-Tn) in rows, with the data in those rows describing relationships with other types, values, and/or terms (which are inhabitants of types, generally corresponding to instances). Note that relationships may be with data that is maintained in other tables.

As described herein, there may be various types, including abstract types, sub-types, simple types (that mimic the native types of the relational database management system upon which this model may be implemented), relation types and types of composite structures. Inhabitants of types may include constants, variables, functions and composite terms.

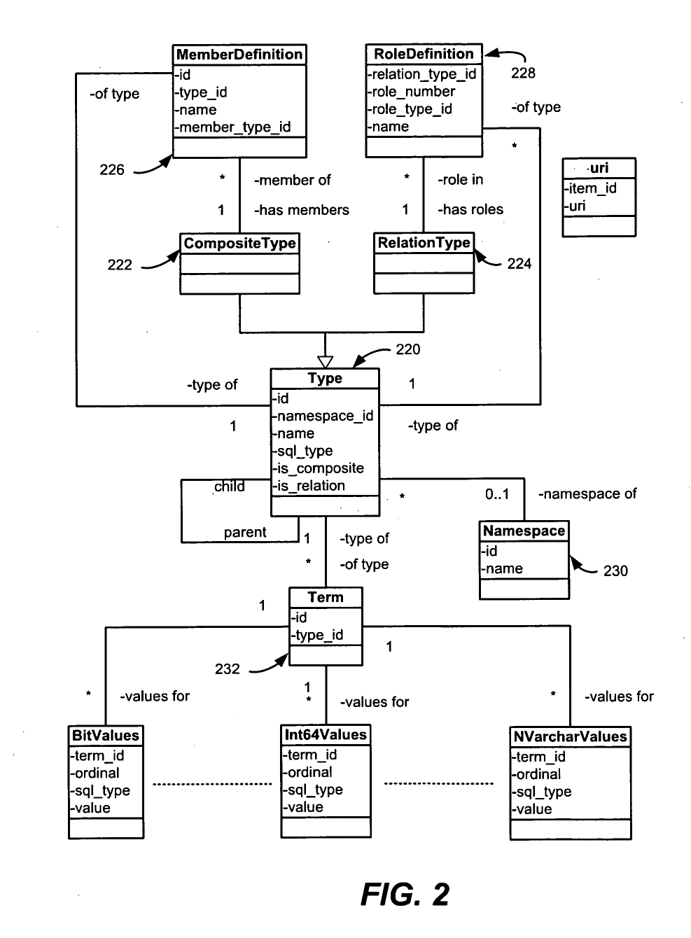

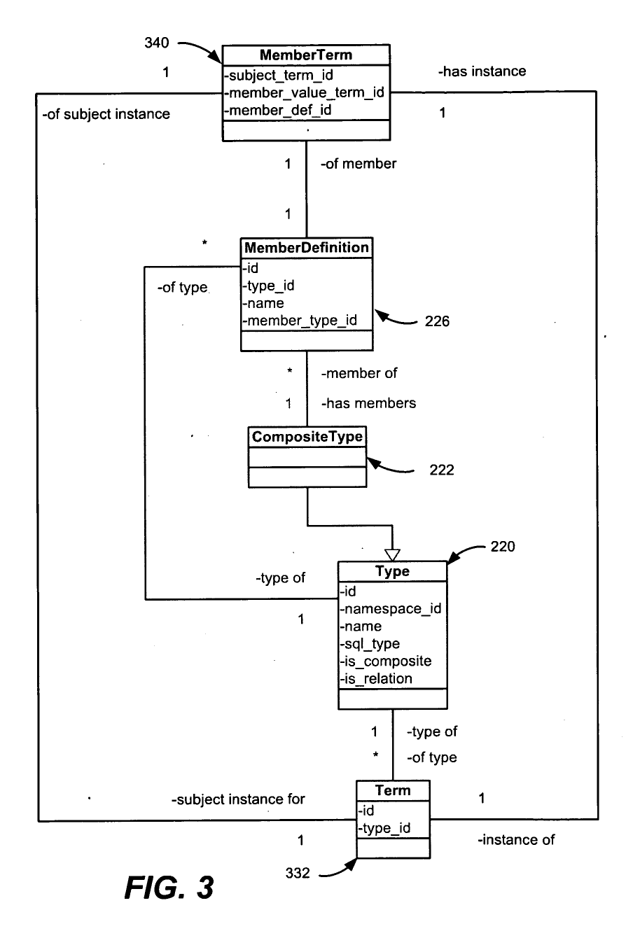

Turning to an explicit representation of types, relationships among types and relationships between types and instances in one implementation, FIGS. 2 and 3 are Unified Modeling Language (UML) diagrams that represent example relationships among types and relationships between types and terms. Note that classical object databases are capable of storing and retrieving complex, non-relational structures, while recent relational database technology can store instances of classes and of XML schemas by “shredding” them into relational structures. However, the relational database embodiment of such a system is not particularly useful when dealing with rapid evolution. In contrast, the system exemplified in FIGS. 2 and 3, in which types and inhabitants of types are explicitly represented along with their relationships one with the other, facilitates such rapid changes. Further, the types that may be represented include types both from functional languages and object oriented languages.

In FIG. 2, a type 220 is represented as being a composite type 222 of a composite structure or a relation type 224. As represented in FIG. 2 composite types have member definitions 226, while relation types have role definitions 228. In this model, types may be associated with a namespace 230, and may have child and parent relationships with other types.

Further, types are inhabited by a term 232, which as described above may include constants, variables, functions and composite terms.

As represented in FIGS. 2 and 3, the member definition (e.g., 226) of a composite type (e.g., 222) has a member term 340. In other words, the member definition 226 of a composite type 222 has a member term 340 corresponding to its term 332.

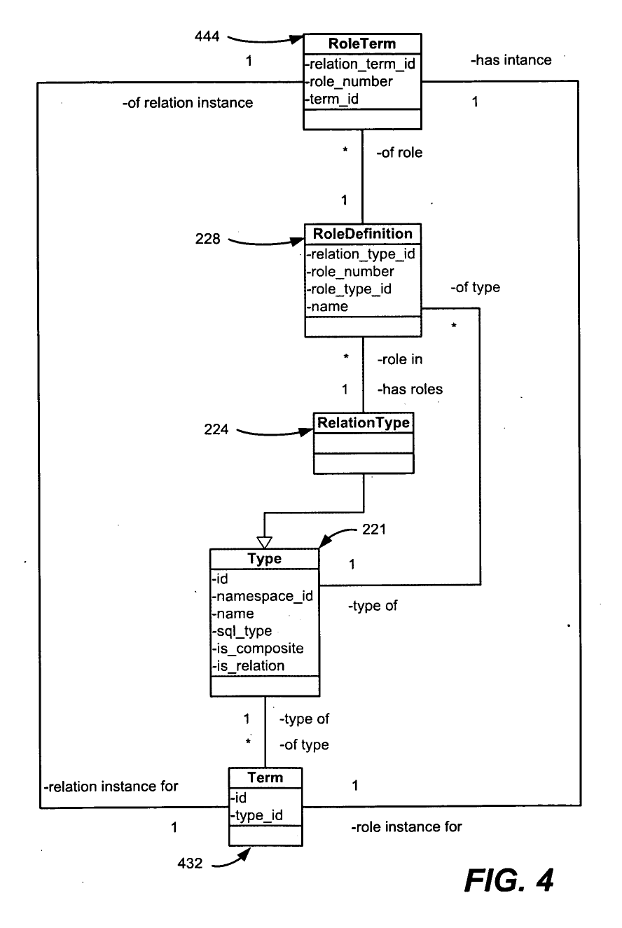

As represented in FIGS. 2 and 4, the role definition 228 of a relation type 224 has a role term 444 that corresponds to its term. In other words, the role definition 228 of a relation type 224 has a role term 444 corresponding to its term 432.

A new relationship is established by adding a new row to the database table to represent a new relation type. A new instance (term) of an existing relation type may also be created. Relationships may be removed by removing rows. Relationships are simply one type of proposition that can be represented in the system. The framework can record any sort of proposition including the probability in which these propositions are likely to occur and over which span of time. In this way, the database table may change its state rapidly, without needing to change the database schema.

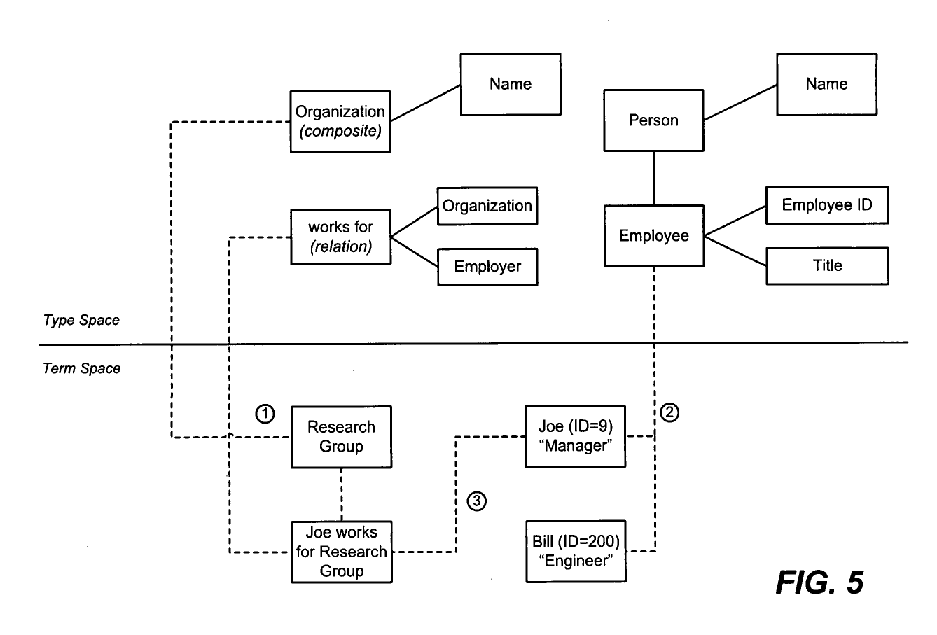

By way of an example filled in with simplified data, FIG. 5 shows a hypothetical enterprise structure configured with types and terms. As can be seen, the types and terms are represented as nodes of a graph, with the edges (dashed lines) representing relationships between the nodes, including between types and terms, and between different terms. The types may be considered as being in a type space, while the terms may be considered as being in a term space.

As can be seen in this example, to model some part of an enterprise, an “Organization” node is created as a composite type, which is associated with a name member. The “works for” node is a relation type that has roles of “Organization” and “Employer.” A “Person” node is another composite type that is created in this model, is associated with a name member, and has a child node of “Employee” that inherits from the person node and is associated with an employee ID member and Title member.

It may be noted that a member definition and a role definition are nearly identical concepts. Both are associated with an “enclosing” type, are themselves of a type, and are given a name within their enclosing type. One difference is that the order of role definitions is essential to their definition whereas member definitions have no essential order. However, the distinction between members and roles reduces complexity and thus is practical to maintain in most scenarios. Moreover, in one implementation, composite type members are not ordered whereas relation type roles are ordered. For example, consider a composite type “BookAuthor” with members “Author” and “Book”. If this composite type has a display string of “is author of”, a certain automated system may be unable to differentiate between “Mary is author of Document” or “Document is author of Mary”. However, in a relation type, IsAuthorOf, “Author” is role 0, for example and “Book” is role 1, whereby the automated system knows to emit the statement “Mary is author of Document”.

Predicate logic may be used to express the nodes and their relationships, as in the following table in which the circled numerals in FIG. 5 correspond to the labels:

| Label # | Subject, Predicate, Object |
|---|---|
| 1 | Organization, Has Name, “Research Group” |
| 2 | Person, Has Name, “Joe” |
| 3 | Joe, works for, “Research Group” |
| . . . | . . . |

As a result of the types and terms, and their relationships, it is straightforward to change the state that is represented by a database by simply adding a row to describe the updated environment, rather than changing the schema. For example, a new row may be added to a table to specify a new relationship between two nodes; similarly a row may be deleted. This is highly useful with scientific data, where new relationships are created, considered and discarded frequently. Further note that the relationships may be more than two dimensions, e.g., “Joe works for Research Group (which) is a Specially Funded Sub-group (that) is under Medical Devices” is a feasible string corresponding to three subject, predicate, object triplets.

Note that the relationship need not be known at the time the type is created. For example, consider a researcher that discovers a new type of protein. A composite type is created for the protein with appropriate terms. As the protein is further researched, its relationships with other types are discovered or hypothesized, with a relation type and appropriate role or role for that relation type added for each new relationship, simply by adding a row to the existing table.

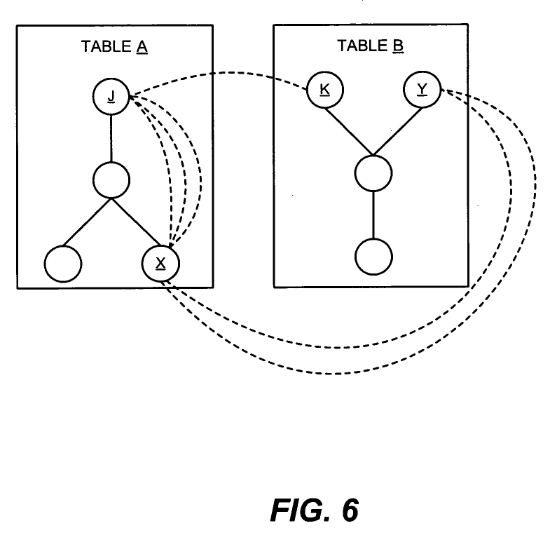

Moreover, two types (nodes) may have multiple relationships with one another, as generally represented in FIG. 6, where two the nodes J and X have three different types of relationships with one another, and the two nodes X and Y have two different types of relationships with one another. Note that relationships can span tables, as exemplified in FIG. 6 by the dashed lines between nodes (J and K, X and Y) of Table A and Table B.

As can be seen, the explicit representation of types, including relation types and types of composite structures, along with inhabitants of types, including constants, variables, functions and composite terms, provides a database that evolves to represent concepts simply by adding or removing rows.

### Exemplary Operating Environment

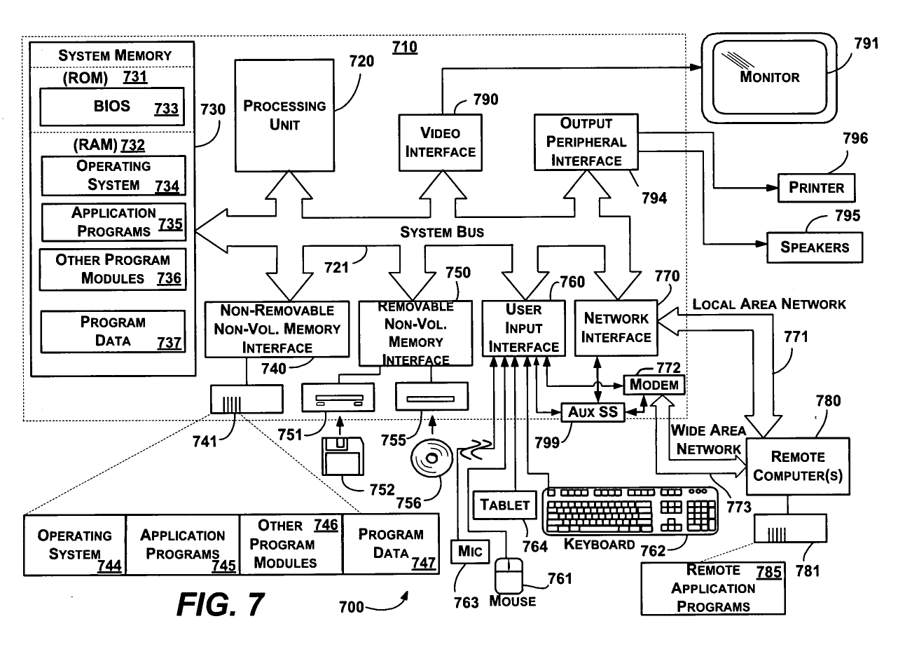

FIG. 7 illustrates an example of a suitable computing and networking environment 700 on which the examples of FIGS. 1-6 may be implemented. The computing system environment 700 is only one example of a suitable computing environment and is not intended to suggest any limitation as to the scope of use or functionality of the invention. Neither should the computing environment 700 be interpreted as having any dependency or requirement relating to any one or combination of components illustrated in the exemplary operating environment 700.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 7, an exemplary system for implementing various aspects of the invention may include a general purpose computing device in the form of a computer 710. Components of the computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 710 typically includes a variety of computer-readable media. Computer-readable media can be any available media that can be accessed by the computer 710 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 710. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736 and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media, described above and illustrated in FIG. 7, provide storage of computer-readable instructions, data structures, program modules and other data for the computer 710. In FIG. 7, for example, hard disk drive 741 is illustrated as storing operating system 744, application programs 745, other program modules 746 and program data 747. Note that these components can either be the same as or different from operating system 734, application programs 735, other program modules 736, and program data 737. Operating system 744, application programs 745, other program modules 746, and program data 747 are given different numbers herein to illustrate that, at a minimum, they are different copies. A user may enter commands and information into the computer 710 through input devices such as a tablet, or electronic digitizer, 764, a microphone 763, a keyboard 762 and pointing device 761, commonly referred to as mouse, trackball or touch pad. Other input devices not shown in FIG. 7 may include a joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. The monitor 791 may also be integrated with a touch-screen panel or the like. Note that the monitor and/or touch screen panel can be physically coupled to a housing in which the computing device 710 is incorporated, such as in a tablet-type personal computer. In addition, computers such as the computing device 710 may also include other peripheral output devices such as speakers 795 and printer 796, which may be connected through an output peripheral interface 794 or the like.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include one or more local area networks (LAN) 771 and one or more wide area networks (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760 or other appropriate mechanism. A wireless networking component 774 such as comprising an interface and antenna may be coupled through a suitable device such as an access point or peer computer to a WAN or LAN. In a networked environment, program modules depicted relative to the computer 710, or portions thereof, may be stored in the remote memory storage device. By way of example, and not limitation, FIG. 7 illustrates remote application programs 785 as residing on memory device 781. It may be appreciated that the network connections shown are exemplary and other means of establishing a communications link between the computers may be used.

An auxiliary subsystem 799 (e.g., for auxiliary display of content) may be connected via the user interface 760 to allow data such as program content, system status and event notifications to be provided to the user, even if the main portions of the computer system are in a low power state. The auxiliary subsystem 799 may be connected to the modem 772 and/or network interface 770 to allow communication between these systems while the main processing unit 720 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a system comprising, a database table that contains rows of type data representing types, and term data representing terms, in which at least one type is a relation type that specifies a relationship between two other types, between another type and a term, or between two terms.

2. The system of claim 1 further comprising means for establishing a new relationship by adding a row to the database table to represent a new relation type.

3. The system of claim 1 further comprising means for establishing a new relationship by adding a row to the database table to represent a new term of an existing relation type.

4. The system of claim 1 wherein at least one of the types is a composite type that has a relationship with a member type according to a member definition.

5. The system of claim 1 wherein the relation type has a relationship with a relation term according to a role definition.

6. The system of claim 1 wherein two types have at least two relationships with one another, including via the relation type and at least one other relation type.

7. The system of claim 1 wherein a type and a term have at least two relationships with one another, including via the relation type and at least one other relation type.

8. The system of claim 1 wherein a term and another term have at least two relationships with one another, including via the relation type and at least one other relation type.

9. The system of claim 1 wherein the relation type specifies that a type or a term of the database table has a relationship with a type or a term of another database table.

10. The system of claim 1 wherein the database table models relationships between scientific concepts.

11. One or more computer-readable media having stored thereon a data structure, comprising rows of type data representing types, including a row that includes a relation term that inhabits a relation type, whereby accessing the row that includes the relation term relates the relation term to another term.

12. The computer-readable media of claim 11 wherein and a row that represents a relation role term associated with the relation term.

13. The computer-readable media of claim 11 wherein the relation type is associated with the role term according to a role definition.

14. The computer-readable media of claim 13 wherein one of the types is a composite type associated with a member term according to a member definition.

15. The computer-readable media of claim 13 wherein at least two of the types are composite types each having a composite term, and wherein the relation term relates one composite term to the other composite term.

16. The computer-readable media of claim 12 wherein the data structure includes a row corresponding to a relation type having a term that relates to a type or term in another data structure.

17. One or more computer-readable media having stored thereon a data structure, comprising rows of type data representing types, including a row that includes a member term that inhabits a composite type, and data that relates the member term to another member term, whereby accessing the row that includes the member term provides access to the other member term.

18. The computer-readable media of claim 17 wherein one of the types is a composite type associated with the member term according to a member definition.

19. The computer-readable media of claim 17 wherein the data that relates the member term to the other member term is a relation term of a relation type row.

20. The computer-readable media of claim 17 wherein the relation type is associated with the role term according to a role definition.
